(19) United States
(12) Patent Application Publication
(10) Pub. No.: US 2024/0339793 A1
(43) Pub. Date: Oct. 10, 2024

(54) Contact Module with Improved Shielding and Monolithically Folded Housing

(71) Applicant: TE Connectivity Belgium BV, Oostkamp (BE)

(72) Inventors: Peter DEVOS, Oostkamp (BE); Koen LIEBAERT, Oostkamp (BE); Rik DANNEELS, Oostkamp (BE); Ronny DEGRYSE, Oostkamp (BE); Peter BAERTSOEN, Oostkamp (BE)

(73) Assignee: TE Connectivity Belgium BV, Oostkamp (BE)

(21) Appl. No.: 18/624,188

(22) Filed: Apr. 2, 2024

(30) Foreign Application Priority Data
Apr. 4, 2023 (EP) 23166430.1

(51) Int. Cl. H01R 24/50; H01R 13/42; H01R 13/6581; H01R 13/6594; H01R 13/6597; H01R 43/18

(52) U.S. Cl. CPC H01R 24/50; H01R 13/42; H01R 13/6581; H01R 13/6594; H01R 13/6597; H01R 43/18

(57) ABSTRACT

The invention relates to a contact module for transmission of high-frequency signals, wherein the contact module comprises at least one electrically conductive contact element adapted for transmitting the high-frequency signals, a dielectric insulator at least sectionally surrounding the at least one contact element and an electrically conductive shielding housing at least sectionally surrounding the dielectric insulator with the at least one contact element inside, wherein the shielding housing is monolithically folded around the dielectric insulator. The invention further relates to a set comprising two such contact modules. The invention further concerns an electrical connector comprising at least one contact module and a connector housing. The contact module has an improved shielding performance, a simplified assembly and reduced number of components.

This application claims priority to European Patent Application Ser. No. 23166430.1 filed on Apr. 4, 2023 which is incorporated herein by reference in its entirety.

The invention pertains to a contact module for the transmission of high-frequency signals, and a method for manufacturing such a contact module. Further, the invention relates to a set comprising two such contact modules. In addition, the invention relates to an electrical connector comprising at least one contact module and a connector housing.

Contact modules are used for interconnecting electrical components, such as printed circuit boards and connectors. The contact modules comprise one or more conductors, which have to be provided with a dielectric and a shielding.

Conventional contact modules, such as chiclet connectors, have two conductors in one component. In order to provide these with a dielectric and a shielding, complex manufacturing and assembly processes are required.

In general, contact modules should provide good electrical shielding and, at the same time, be assembled easily.

It is therefore an object of the invention to provide a contact module with improved shielding performance and a simplified assembly.

This object is solved by a contact module for transmission of high-frequency signals,
wherein the contact module comprises at least one electrically conductive contact element adapted for transmitting the high-frequency signals, a dielectric insulator and an electrically conductive shielding housing;
wherein the dielectric insulator surrounds the at least one contact element at least sectionally;
wherein the dielectric insulator with the at least one contact element is held and surrounded by the shielding housing; and
wherein the shielding housing is folded monolithically around the dielectric insulator.

The monolithic, single-piece structure of the shielding housing facilitates the assembly process and reduces the number of parts of the contact module.

The above invention may be further improved by adding one or more of the features described in the following, whereby each of these features is advantageous in itself, and may be combined independently and/or in any desired manner with any of the other features described in the following. The features described hereinbelow apply equally to the contact module and the method of manufacturing the contact module, even if a particular feature is mentioned only in the context of one of the contact module and the method of its manufacture. For example, if the contact module is described as comprising a feature, it is clear that the manufacturing process may comprise this feature. Further, if the manufacturing method comprises a step in which a particular feature of the contact module is manufactured, it is clear that the contact module may comprise this feature.

To facilitate the manufacturing the shielding housing may be made in its entirety from folded sheet metal. In this embodiment, the shielding housing may surround the dielectric insulator by being folded around the dielectric insulator.

According to a further embodiment of the invention, the at least one contact element may be inserted into a receptacle of the dielectric insulator and/or the dielectric insulator may be set-in into an access opening of the shielding housing. Due to the good confinement of the contact element within the dielectric insulator and the shielding housing, shielding performance is improved.

To improve guidance of the contact element during assembly and thus reduce the risk of damage, the receptacle of the dielectric insulator may comprise a through hole and/or a laterally open channel into which the at least one contact element is inserted. The through hole may also be used to adjust the impedance. The receptacle may comprise a groove, into which the contact element may be inserted. After insertion, the contact element may be at least partially received in the groove of the receptacle. In particular, the contact element then may abut a ground of the receptacle.

According to another aspect, the through hole and/or the channel may comprise at least two sections each having a different inner width. In this way, areas with good accessibility are provided, leading to a simplification of the assembly. Also impedance may be adjusted by the two sections.

In accordance with another embodiment of the invention, the at least one contact element may comprise a hump located in the section with the narrower width of the through hole and/or the channel, wherein the hump forms a limit stop for lateral and/or torsional movement of the at least one contact element. By preventing relative movement of the contact element to the other components of the contact module, friction and thus wear is reduced.

In another aspect, the contact module may form a connection section configured to be attached to a printed circuit board and/or a mating section configured to be mated with a counterpart contact of the high-frequency signal transmission line. The contact section may comprise one or more tabs that are formed by the shielding housing. The contact section may be configured to be pressed into complementary holes in e.g. a PCB.

According to a further aspect of the invention, the at least one contact element may protrude out of the dielectric insulator, and the dielectric insulator may comprise a positioning pin extending parallel with the at least one contact element. In the assembled state, the positioning pin improves the axial guidance of the contact element and reduces the mechanical load on the contact element, such as bending moments. The protrusion enables the contact elements to make contact with other current-carrying components.

The at least one contact element may also protrude out of the shielding housing. In particular, the at least one contact element may protrude out of the shielding housing at the connection section. Analogously, the positioning pin of the dielectric insulator may be located at the connection section.

In another embodiment, the positioning pin may protrude farther than the at least one contact element. This structural feature has the advantage of a polarized insertion direction of the contact module when assembling with other components such as a printed circuit board. The user can thus recognize a faulty assembly e.g. by the contact module sticking out of the printed circuit board.

According to another aspect, at least one of the shielding housing, the dielectric insulator and the at least one contact element may comprise two legs oriented at an angle with respect to each other. In particular, the angle may be substantially 90°, such that the legs are arranged in an L-shape. Other shapes, such as a V-shape are of course also possible. In this way, the contact module is enabled to connect components whose insertion directions are not parallel to each other. This is advantageous in terms of the space-saving assembly of such components.

The angle between the legs may be formed by a bend of the contact element, the bend being located between the connection section and the mating section. The bend may be spaced apart from the connection section and the mating section.

The at least one contact element may be inserted into the receptacle along a straight insertion direction. Alternatively, the contact element may be placed in the receptacle or may be slid, pressed, or pushed into the receptacle. The insertion direction may extend along a longitudinal axis of one leg of the receptacle. In case the dielectric insulator provides a through hole, the insertion direction may also extend along the longitudinal axis of the through hole. During insertion, a longer leg of the contact element may enter the receptacle through an axial opening in the receptacle. The axial opening of the receptacle may be positioned at an axial end face of one leg of the dielectric insulator. The contact element may be moved along the insertion direction, until the shorter leg of the contact element abuts against the ground of the receptacle. In this state, the contact element may not be further inserted and both legs of the contact element may be received in a groove of the receptacle.

Afterwards, the dielectric insulator with the at least one contact element received in the groove of the receptacle may be inserted into the shielding housing along the straight insertion direction. The insertion direction may extend along the longitudinal axis of the longer or shorter leg of the pre-folded shielding housing. The longitudinal axis of the longer leg of the shielding housing, the longitudinal axis of the longer leg of the dielectric insulator, and the longitudinal axis of the longer leg of the contact element may be aligned along the straight insertion direction. In this way, the shielding housing, the dielectric insulator, and the contact element may be assembled along the same inserting direction.

During insertion along the inserting direction, the dielectric insulator with the at least one contact element inside may be inserted into the shielding housing through an access opening. The insertion may follow a linear trajectory, i.e. be oriented along an insertion direction. The normal axis of the access opening may extend along the insertion direction. The access opening should be large enough for the at least one contact element with the at least one contact element to pass through into the shielding housing at least partially. Thus, the dielectric insulator with the at least one contact element inside may be in particular fully inserted into the shielding housing.

Each of the shielding housing, the dielectric insulator and the at least one contact element may comprise a segment with a round cross-section and a segment with a rectangular cross-section. Further, a third segment with a square cross-section may be present between the other two segments, whereby, the segment with a round cross-section or the segment with a square cross-section may be separated from the segment with a rectangular cross-section by the bend. In particular, a transition between the round cross-section and the rectangular cross-section may comprise a shoulder or step extending away from the signal transmission path. Each of the shielding housing, the dielectric insulator and the at least one contact element may comprise such a transition. The dielectric insulator may comprise, in the segment with the round cross-section, the through hole extending along the signal transmission path. Further, the dielectric insulator may comprise, in the segment with the rectangular cross-section, the laterally open channel extending along the signal transmission path.

In order to be able to transmit signals with tolerance to interference, the contact module may comprise two contact elements forming a differential pair both surrounded at least sectionally by the dielectric insulator and the shielding housing.

According to another embodiment, a set comprising two contact modules according to one of the above embodiments may be provided, wherein the two contact modules differ in their lengths. The length is defined as the distance between the connection section and the mating section of each contact module along the contact element. Due to this embodiment, a polarized and thus less error-prone mating process of the set with other components is established. Further, the set may replace a chiclet. Both contact modules may have the same fixation plane and/or the same contact plane.

In another aspect of the invention, an electrical connector may be provided, which comprises at least one contact module according to one of the above embodiments and a connector housing with a mating face and at least one contact opening leading into the mating face, wherein the at least one contact module is received in the at least one contact opening protruding into the mating face. Such a connector can be used to set up an electrical connection between several components, which is easy to assemble.

According to another embodiment of the invention a method for manufacturing a contact module for transmitting high-frequency signals may be provided, wherein the method may comprise the steps of:
providing an electrically conductive shielding housing that is folded around an inner volume that is accessible through an access opening of the shielding housing, a dielectric insulator being located in the inner volume of the shielding housing, and at least one electrically conductive contact element being received in the dielectric element,
closing the access opening by further folding the shielding housing.

A contact module that is manufactured according to this method can be produced cost-effectively, particularly within the context of an automated production.

In another embodiment, the shielding housing may be provided as a part with a flat shape, wherein the shielding housing may be folded to surround the inner volume with the access opening leading into the inner volume, and wherein the dielectric insulator may be inserted through the access opening into the inner volume of the shielding housing. A contact module assembled by this method can be produced in a cost-effective and time-saving way, as the process steps can be well automated.

According to another aspect, the shielding housing may be provided attached on a metal strip and may remain on the metal strip at least until the access opening is closed. In this way, the handling and transportation of the shielding housing before the assembly is simplified.

In the following, the invention will be explained exemplarily and in more detail with reference to the drawings and in accordance with several embodiments, the different features of which can be combined with one another as desired in accordance with the above general description. Moreover, a feature may be omitted from the below embodiments if its technical effect is not required in a particular application. Likewise, a feature described above that is not present in an embodiment as described below may be added if its technical effect is not essential for a particular application.

In the following, the same reference numerals are used for elements that correspond to each other with respect to at least one of structure and function.

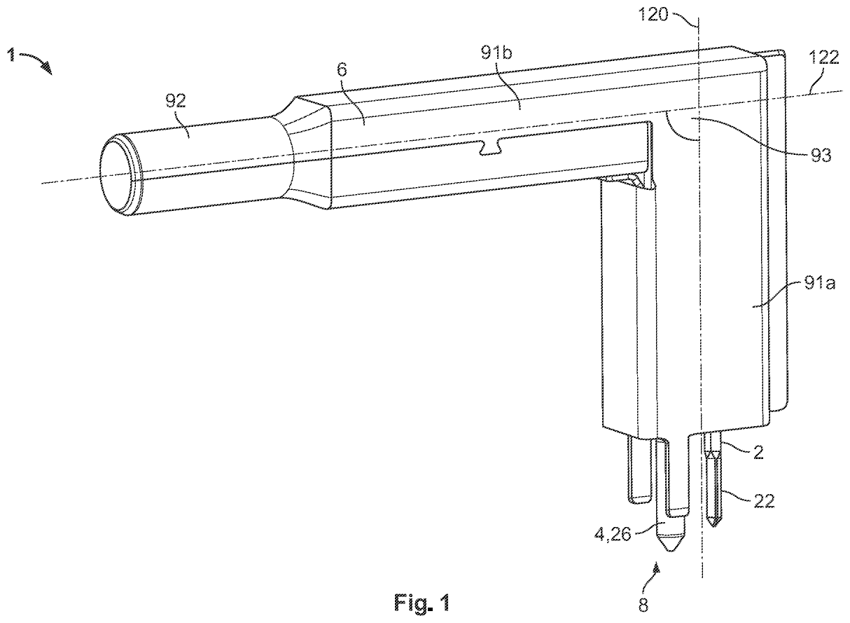

FIG. 1 shows a schematic perspective view of a contact module according to a possible embodiment of the invention;

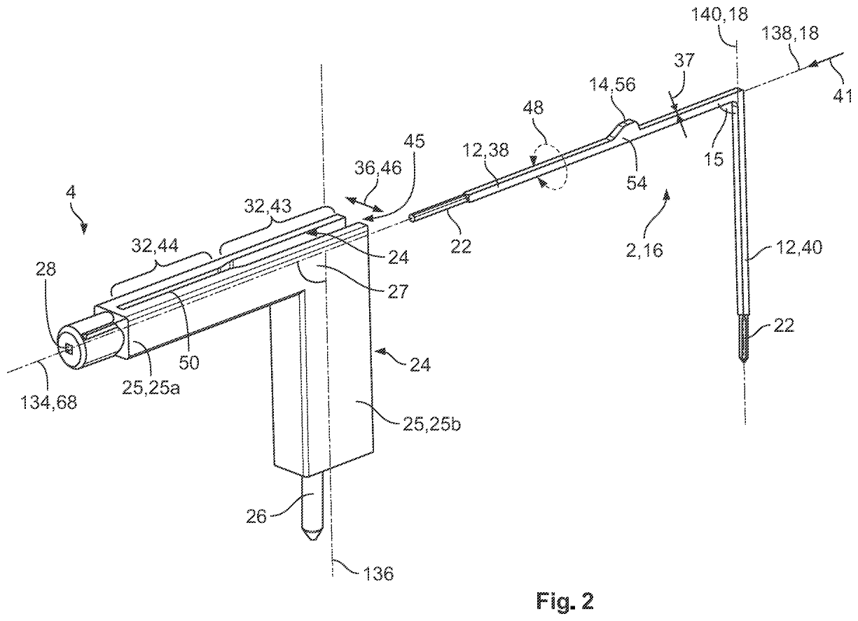

FIG. 2 shows a schematic exploded view of a contact element and a dielectric insulator according to a possible embodiment of the invention;

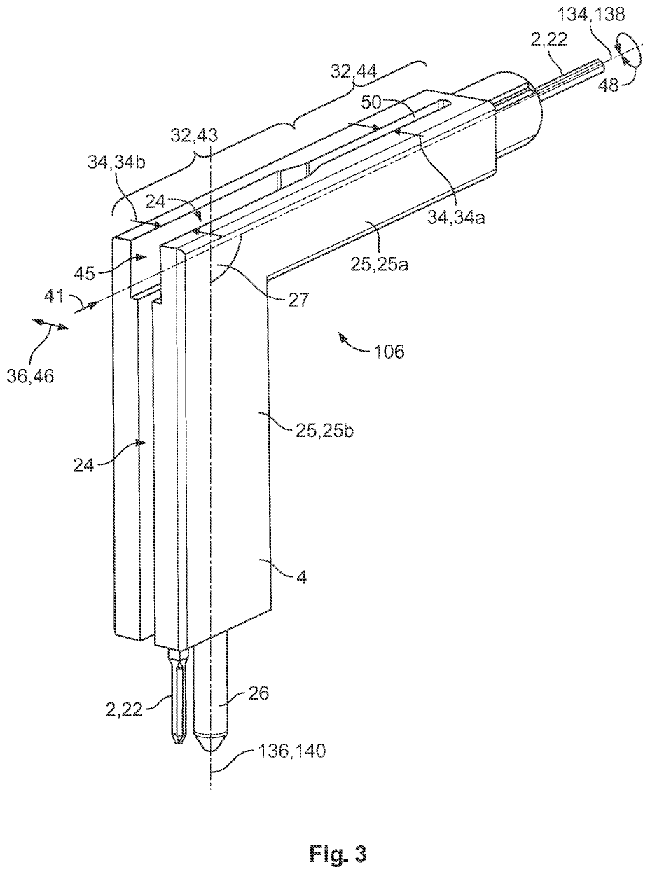

FIG. 3 shows a schematic perspective view of a contact element and a dielectric insulator according to a possible embodiment of the invention;

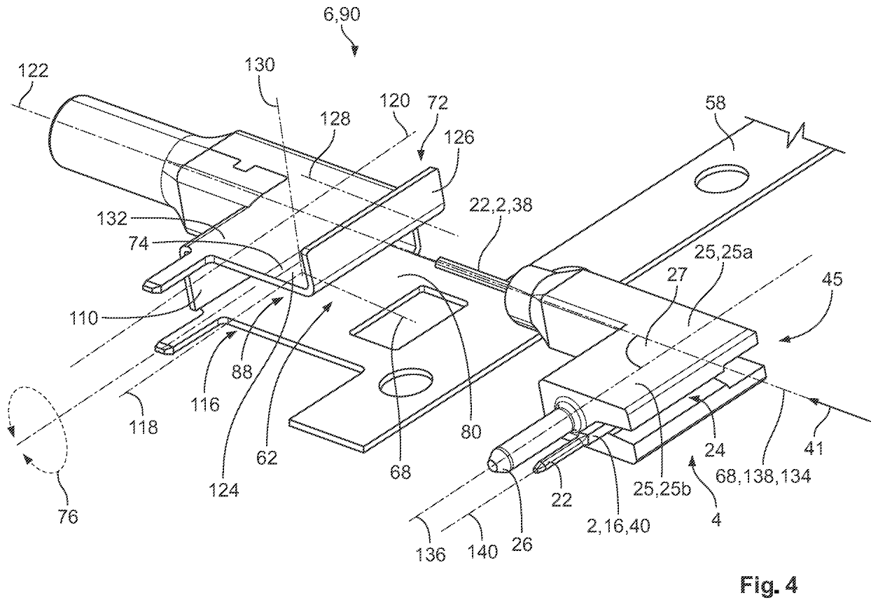

FIG. 4 shows a schematic perspective view of a shielding housing, a contact element and a dielectric insulator according to a possible embodiment of the invention;

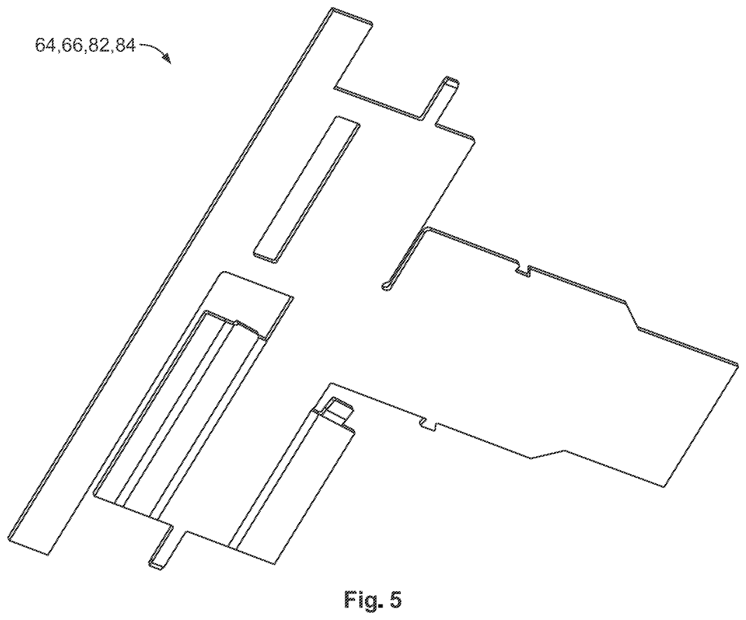

FIG. 5 shows a schematic perspective view of an unfolded shielding housing provided as a part with a flat shape according to a possible embodiment of the invention;

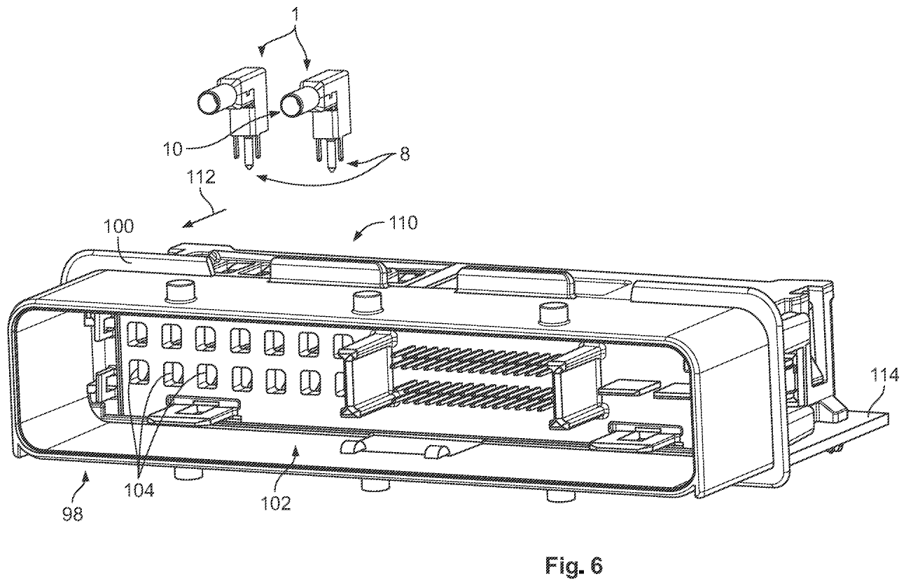

FIG. 6 shows a schematic perspective view of an electrical connector according to a possible embodiment of the invention, before the contact modules are assembled.

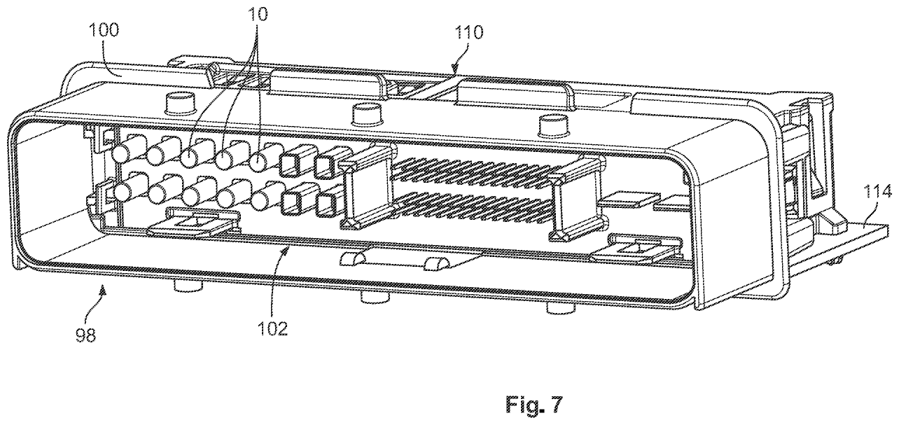

FIG. 7 shows a schematic perspective view of an electrical connector according to a possible embodiment of the invention, after the contact modules are assembled.

In the following, the structure of a contact module 1 according to several possible embodiments will be described with reference to FIG. 1 to FIG. 5.

The contact module 1 comprises a contact element 2, a dielectric insulator 4 and a shielding housing 6. According to a preferred embodiment, the contact module 1 may further comprise a connection section 8 and/or a mating section 10.

The contact element 2 comprises two legs 12 and preferably a hump 14. One leg 12 may be shorter than the other leg 12, or both legs may have the same length. The legs 12 may be oriented perpendicular with respect to each other. The legs 12 may also be oriented in any angle 15 with respect to each other. The two legs 12 may span a plane.

The contact element 2 may be a stamped contact pin 16 that extends along a signal transmission path 18. The signal transmission path 18 extends along the longitudinal axes of the legs 12. The contact elements 2 may comprise pin-shaped tips 22. The hump 14 is a protrusion that extends along the longitudinal axis 140 of the one leg 12, e.g. the shorter leg, of the contact element 2. The hump further extends away from the respective leg 12 and is located in the plane of the two legs.

The dielectric insulator 4 may be an injection molded resin part. The dielectric insulator 4 comprises two legs 25 and a receptacle 24. The legs 25 are oriented in an angle 27 with respect to each other. In particular, the legs 25 may be oriented perpendicular with respect to each other. On an end of one leg 25, the dielectric insulator 4 may comprise a positioning pin 26 that extends parallel to the contact element 2. In particular, the positioning pin 26 may protrude farther than the contact element 2.

The receptacle 24 comprises an optional through hole 28 and a channel 30. Both the longitudinal axis 68 of the through hole 28 and the longitudinal axis of the channel 30 extend parallel to the longitudinal axis of one, e.g. the longer leg 25a of the dielectric insulator 4. In particular, the through hole 28 may lead into the channel 30. The through hole 28 and, additionally or cumulatively, the channel 30 may comprise at least two sections 32. The sections 32 each have a different inner width 34, which is measured in a width direction 36. In particular, one inner width 34a may correspond with the thickness 37 of the contact element 2 and the other width 34b may be larger. This has the advantage that a more stable core can be used in the molding tool in the production process of the dielectric insulator 4.

For assembling the contact module 1, the contact element 2 may be inserted into the receptacle 24 of the dielectric insulator 4. In particular, the contact element 2 may be removably set-in into the receptacle 24. The process of the set-in may mean that the contact element 2 is inserted, slid, pressed or pushed into the receptacle 24 or that the contact element 2 is placed inside the receptacle 24. Alternatively, the contact element 2 may be overmolded with the dielectric insulator 4.

When being inserted, the contact element 2 is moved towards the dielectric insulator 4 along an insertion direction 41. The longitudinal axis 134 of the one, e.g the longer leg 38 of the contact element 2 extends along the insertion direction 41 and the shorter leg 40 of the contact element 2 extends perpendicularly to the insertion direction 41. In case the dielectric insulator 4 is provided with a through hole 28, the longitudinal axis 68 of the through hole 28 extends along the insertion direction 41.

As the contact element 2 is inserted along the insertion direction 41, the tip 22 of the longer leg 38 of the contact element 2 first enters the receptacle 30 of the longer leg 25a of the dielectric insulator 4. The tip 22 of the longer leg 25a enters the receptacle 30 via an axial opening 45. After passing both the section with wider width 43 and the section with narrower width 44 along the insertion direction 41, the tip 22 enters the through hole 28. The one leg 38 is further moved along the insertion direction 41, until the other, preferably shorter, leg 40 of the contact element 2 abuts against the ground wall 42 (not visible in the drawings) of the receptacle 24. Then, the contact element 2 cannot be further inserted into the receptacle 24 along the insertion direction 41.

In the assembled state 106, the contact element 2 may completely penetrate the through hole 28 and protrude out of the dielectric insulator 4.

Further, the hump 14 is located in the section with the narrower width 44. If the contact element 2 is moved in a lateral direction 46 and/or along a torsional direction 48, the sidewalls 54 of the hump 14 abut against the inner surface 50 of the receptacle 24. In this way, the hump 14 forms a limit stop 56, limiting movement of the contact element 2 in the lateral direction 46 and along the torsional direction 48.

After the contact element 2 is completely set-in into the receptacle 24 as described above, the contact element 2 and the dielectric insulator 4 may be assembled with the shielding housing 6. Of course, it may also be possible to insert the dielectric insulator 4 into the shielding housing 6 first and the contact element 2 second. Likewise, any other sequencing of assembling the contact element 2 and the dielectric insulator 4 with the shielding housing 6 may be possible.

The shielding housing 6 may be formed, in particular stamped, bent and/or folded, from a single piece of sheet material. It thus is a monolithic, i.e. integral part. The shielding housing 6 may be provided attached to a metal strip 58, e.g. via material bridges 60. The material bridges 60 that join the shielding housing 6 and the metal strip 58 may remain until an access opening 62 is closed. To assemble the contact element 2 and the dielectric insulator 4 with the shielding housing 6, the shielding housing 6 may be monolithically folded around the dielectric insulator 4. In particular, the unfolded shielding housing 6 may be directly folded around the dielectric insulator 4. In the unfolded state 64, the shielding housing 6 may be formed as a monolithic part 66. During folding, the shielding housing 6 remains in one piece.

According to a method 108 of a possible embodiment, the dielectric insulator 4 and the contact element 2 may be inserted into the access opening 62 of a pre-folded shielding housing 90. The pre-folded shielding housing 90 may also generally be referred to as shielding housing 6.

The pre-folded shielding housing 90 comprises two legs 91, e.g. a shorter leg 91a and a longer leg 91b—or two legs of equal length—that are oriented in an angle 93 with respect to each other. In particular, the legs 91 may be oriented perpendicular to each other. The lengths of the legs 91 substantially correspond to the lengths of the legs of the dielectric insulator.

The shorter leg 91a of the pre-folded shielding housing 90 is configured for receiving both the shorter leg 25a of the dielectric insulator 4 and the shorter leg 40 of the contact element 2. The longer leg 91b of the pre-folded shielding housing 90 is configured for receiving both the longer leg 25b of the dielectric insulator 4 and the longer leg 38 of the contact element 2. The longer leg 91b of pre-folded shielding housing 90 may comprise a cylindrical end portion 92, which is configured to receive at least the tip 22 of the contact element 2.

The pre-folded shielding housing 90 further comprises the access opening 62 and a bottom opening 116. The normal axis 68 of the access opening 62 extends along the longitudinal axis 122 of the longer leg 91b of the pre-folded shielding housing 90. The normal axis 118 of the bottom opening 116 extends along of the longitudinal axis 120 of the shorter leg 91a of the pre-folded shielding housing 90. Via the access opening 62, both the dielectric insulator 4 and the contact element 2 may be inserted. The bottom opening 116 is provided, so that the positioning pin 26 and the tip 22 of the shorter leg 40 of the contact element 2 may protrude from the pre-folded shielding housing 90, after the dielectric insulator 4 and the contact element 2 have been inserted into the pre-folded shielding housing 90.

The pre-folded shielding housing 90 further comprises at least one closing flap 72. The closing flap 72 may comprise a horizontal surface 124 and a vertical surface 126 that may be oriented rectangular with respect to each other. The closing flap 72 does not necessarily have to have a vertical surface 126 and a horizontal surface 124, as different geometries of the closing flap 72 are possible. The normal axis 128 of the vertical surface 126 of the open closing flap 72 extends along the longitudinal axis 120 of the longer leg 91b of the pre-folded shielding housing 90. The horizontal surface 124 of the open closing flap 72 lies in the same plane as a side portion 132 of the pre-folded shielding housing 90. The horizontal surface 124 of the closing flap 72 is joined with the side portion 132 of the pre-folded shielding housing 90 via a bending edge 74, which extends parallel to the longitudinal axis 120 of the shorter leg 91a of the pre-folded shielding housing 90. The bending edge 74 may be perforated or weakened. The closing flap 72 may be bent around the bending edge 74 along a bending direction 76 that extends circumferentially around the at least one bending edge 74.

Before the closing flap 72 is bent along the bending direction 76, the access opening 62 of the pre-folded shielding housing 90 is accessible. The horizontal surface 124 of the closing flap 72 is large enough to close the access opening 62 of the pre-folded shielding housing 90, after the closing flap 72 is bent along the bending direction 76.

The pre-folded shielding housing 90 encloses an inner volume 88. The inner volume 88 is configured to receive the dielectric insulator 4 with the at least one contact element 2 inside.

For inserting, the dielectric insulator 4 with the contact element 2 inside is moved towards the prefolded shielding housing 90 along the insertion direction 41. The insertion direction 41 extends along the longitudinal axis 122 of the longer leg 91b of the pre-folded shielding housing 90. The longitudinal axis 134 of the longer leg 25a of the dielectric insulator 4 extends along the insertion direction 41 and the longitudinal axis 136 of the shorter leg 25b of the dielectric insulator 4 extends perpendicular to the insertion direction 41, or in another angle, depending on the angle between the legs 25 of the dielectric insulator 4. In order for the dielectric insulator 4 to fit into the inner volume 88 of the pre-folded shielding housing 90, the longitudinal axis 136 of the shorter leg 25b must extend along the longitudinal axis 120 of the shorter leg 91a of the pre-folded shielding housing 90. In case the dielectric insulator 4 is provided with a through hole 28, the longitudinal axis 68 of the through hole 28 extends along the insertion direction 41.

As the dielectric insulator 4 with the contact element 2 inside is inserted along the insertion direction 41, the tip 22 of the longer leg 38 of the contact element 2 first enters the access opening 62 of the pre-folded shielding housing 90. The dielectric insulator 4 is then moved further along the inserting direction 41, until the shorter leg 25b of the dielectric insulator 4 abuts against a backside 110 of the inner volume 88. Thus, the dielectric insulator 4 with the contact element 2 inside cannot be further inserted into the pre-folded shielding housing 90. The shorter leg 25b and the longer leg 25a of the dielectric insulator 4 as well as the contact element 2 are then received inside the pre-folded shielding housing 90.

In this state, the positioning pin 26 of the dielectric insulator 4 and the tip 22 of the shorter leg 40 of the contact element 2 may protrude from the pre-folded shielding housing 90 through the bottom opening 116. In particular, the positioning pin 26 and the tip 22 may protrude along the longitudinal axis 120 of the shorter leg 91a of the pre-folded shielding housing 90 and along the normal axis 118 of the bottom opening 116. The access opening 62 of the pre-folded shielding housing 90 is still open.

After the dielectric insulator 4 and the contact element 2 are inserted into the pre-folded shielding housing 90, the access opening 62 is closed. Therefore, the at least one closing flap 72 is bent along the bending edge 74 and in the bending direction 76. The at least one closing flap 72 may be completely bent, when the horizontal surface 124 of the closing flap 72 is bent through 90°. The normal axis 130 of the horizontal surface 124 then extends along the longitudinal axis 122 of the longer leg 91b of the pre-folded shielding housing 90. The vertical surface 126 of the closed closing flap 72 abuts a ground surface 80 of the pre-folded shielding housing 90. In this way, the bent horizontal surface 124 closes the access opening 62 and the dielectric insulator 4 and the contact element 2 are at least partially enclosed by the pre-folded shielding housing 90.

Before assembling, the shielding housing 6 may also be provided as a part with a flat shape 82. In particular, the shielding housing 6 may be a stamped part. The shielding housing 6 with its flat shape 82 may be provided attached to a metal strip 58. In particular, the metal strip 58 may remain connected with the shielding housing 6 until the access opening 62 is closed.

The shielding housing 6 may be directly bent around the dielectric insulator 4 and the contact element 2. Therefore, the dielectric insulator 4 containing the contact element 2 is first positioned on the part with the flat shape 82. Afterwards, the shielding housing 6 is bent. The dielectric insulator 4 and the contact element 2 are then received inside the inner volume 88 of the shielding housing 6.

All connections within the shielding housing 6 may be established via a forming process, e.g. by bending or folding. In particular, no connection within the shielding housing 6 may be soldered, or glued. The mechanical connections within the shielding housing 6 may be designed as dovetail or folding connections.

FIG. 6 shows an electrical connector 98 before the contact modules 1 are assembled with the electrical connector 98. The electrical connector 98 comprises a connector housing 100 that has a mating face 102 and multiple contact openings 104. The contact openings 104 lead into the mating face 102. The contact openings 104 are provided for receiving the mating sections 10 of the contact modules 1.

For assembling the contact modules 1 with the electrical connector 98, the contact modules 1 are inserted via the back side 110 of the connector housing 100. For this purpose, the contact modules 1 are inserted into the contact openings 104 of the connector housing 100 along the insertion direction 112. Afterwards, the mating sections 10 of the assembled contact modules 1 protrude into the mating face 102 of the connector housing 100 (see FIG. 7).

According to a possible embodiment, the electrical connector 98 may comprise a printed circuit board 114. For assembling the contact modules 1 with the electrical connector 98, the connection sections 8 of the contact modules 1 are then joined with the printed circuit board 114. In particular, a press-fit between the printed circuit board 114 and the connection sections 8 of the contact modules 1 may be established.

### REFERENCE SIGNS

1 contact module
2 contact element
4 dielectric insulator
6 shielding housing
8 connection section
10 mating section
12 legs of the contact element
14 hump
15 angle
16 stamped contact pin
18 signal transmission path
20 longitudinal axis
22 tip
24 receptacle
25 legs of the dielectric insulator
25a longer leg of the dielectric insulator
25b shorter leg of the dielectric insulator
26 positioning pin
27 angle between the legs of the dielectric insulator
28 through hole
30 channel
32 section
34 inner width
34a one inner width
34b the other inner width
36 width direction
37 thickness
38 longer leg of the contact element
40 shorter leg of the contact element
41 insertion direction
42 ground wall
43 section with wider width
44 section with narrower width
45 axial opening
46 lateral direction
48 torsional direction
50 inner surface
52 lateral surface
54 sidewalls
56 limit stop
58 metal strip
60 material bridge
62 access opening
64 unfolded state
66 monolithic part
68 longitudinal axis of the through hole
70 folded segment
72 closing flap
74 bending edge
76 bending direction
78 vertical surface of the folded segment
80 ground surface of the shielding housing
82 part with a flat shape
84 flat shielding housing
86 normal axis of the access opening
88 inner volume
90 pre-folded shielding housing
91a shorter leg of the pre-folded shielding housing
91b longer leg of the pre-folded shielding housing
92 end portion
93 angle between the legs of the pre-folded shielding housing
94 set
96 length
98 electrical connector
100 connector housing
102 mating face
104 contact opening
106 assembled state
108 Method
110 backside
112 insertion direction
114 printed circuit board
116 bottom opening
118 normal axis of the bottom opening
120 longitudinal axis of the shorter leg of the shielding housing
122 longitudinal axis of the longer leg of the shielding housing
124 horizontal surface
126 vertical surface
128 normal axis of the vertical surface
130 normal axis of the horizontal surface
132 side portion
134 longitudinal axis of the longer leg of the dielectric insulator
136 longitudinal axis of the shorter leg of the dielectric insulator
138 longitudinal axis of the longer leg of the contact element
140 longitudinal axis of the shorter leg of the contact element

1. A contact module for transmission of high-frequency signals,
wherein the contact module comprises at least one electrically conductive contact element adapted for transmitting the high-frequency signals, a dielectric insulator and an electrically conductive shielding housing;
wherein the dielectric insulator surrounds the at least one contact element at least sectionally; and
wherein the dielectric insulator with the at least one contact element is held and surrounded by the shielding housing;
and wherein the shielding housing is monolithically folded around the dielectric insulator.

2. The contact module according to claim 1, wherein the at least one contact element is set-in into a receptacle of the dielectric insulator and/or the dielectric insulator is set-in into an access opening of the shielding housing.

3. The contact module according to claim 2, wherein the receptacle of the dielectric insulator comprises a through hole and/or a laterally open channel into which the at least one contact element is inserted.

4. The contact module according to claim 3, wherein the through hole and/or the channel comprises at least two sections each having a different inner width.

5. The contact module according to claim 4, wherein the at least one contact element comprises a hump located in the section with the narrower width of the through hole and/or the channel, wherein the hump forms a limit stop for lateral and/or torsional movement of the at least one contact element.

6. The contact module according to claim 1, wherein the contact module forms a connection section configured to be attached to a printed circuit board and/or a mating section configured to be mated with a counterpart contact of the high-frequency signal transmission line.

7. The contact module according to claim 1, wherein the at least one contact element protrudes out of the dielectric insulator, and wherein the dielectric insulator comprises a positioning pin extending parallel with the at least one contact element.

8. The contact module according to claim 7, wherein the positioning pin protrudes farther than the at least one contact element.

9. The contact module according to claim 1, wherein at least one of the shielding housing, the dielectric insulator and the at least one contact element comprises two legs oriented at an angle with respect to each other.

10. The contact module according to claim 1, wherein the contact module comprises two contact elements forming a differential pair both surrounded at least sectionally by the dielectric insulator and the shielding housing.

11. A pair of contact modules, wherein each contact module is configured according to claim 1, wherein the two contact modules differ in their lengths.

12. An electrical connector comprising at least one contact module according to claim 1 and a connector housing with a mating face and at least one contact opening leading into the mating face, wherein the at least one contact module is received in the at least one contact opening protruding into the mating face.

13. A method for manufacturing a contact module for transmitting high-frequency signals, wherein the method comprises the steps of:
providing an electrically conductive shielding housing that is folded around an inner volume that is accessible through an access opening of the shielding housing, a dielectric insulator being located in the inner volume of the shielding housing, and at least one electrically conductive contact element being received in the dielectric insulator,
closing the access opening by further folding the shielding housing.

14. The method according to claim 13, wherein the shielding housing is provided as a part with a flat shape, wherein the shielding housing is folded to surround the inner volume with the access opening leading into the inner volume, and wherein the dielectric insulator is inserted through the access opening into the inner volume of the shielding housing.

15. The method according to claim 13, wherein the shielding housing is provided attached on a metal strip and remains on the metal strip at least until the access opening is closed.
